(19) United States
(12) Patent Application Publication
(10) Pub. No.: US 2008/0090109 A1
(43) Pub. Date: Apr. 17, 2008

(54) Portable fuel cell power source and methods related thereto

(75) Inventor: Gerard F. McLean, West Vancouver (CA)

Correspondence Address: SCHWEGMAN, LUNDBERG & WOESSNER, P.A., P.O. BOX 2938, MINNEAPOLIS, MN, 55402, US

(73) Assignee: Angstrom Power Inc.

(21) Appl. No.: 11/891,637

(22) Filed: Aug. 10, 2007

Related U.S. Application Data
(60) Provisional application No. 60/837,060, filed on Aug. 10, 2006.

(51) Int. Cl. H01M 8/02

(52) U.S. Cl. 429/12; 29/623.1

(57) ABSTRACT

Embodiments of the invention relate to a fuel cell power source comprising one or more fuel cells, one or more power conditioning components in contact with the one or more fuel cells, fuel storage, an exterior casing in contact with one or more of the fuel cells, power conditioning components or fuel storage, and two or more outputs, wherein at least a portion of the exterior casing is conformed to fit within an existing battery enclosure of an electronic device, such that the outputs are in contact with connections of the existing battery enclosure.

### PRIORITY OF INVENTION

This non-provisional application claims the benefit of priority under 35 U.S.C. § 119(e) to U.S. Provisional Patent Application Ser. No. 60/837,060, filed Aug. 10, 2006, which is herein incorporated by reference.

### BACKGROUND

Extending the runtime of electronic devices represents a well recognized challenge, both to enhance the utility of existing battery powered devices and to accommodate the needs for enhanced energy-using services in new devices. While new devices are starting to be designed with enhanced power sources built-in (e.g. fuel cell powered mobile phones), pre-built devices that have been designed around existing battery power may lack the runtime capability to compete with such new devices.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a cross-sectional view of an electronic device powered by a fuel cell power source, according to some embodiments.

FIG. 2 illustrates a cross-sectional view of an electronic device powered by a fuel cell power source utilizing a modified cover, according to some embodiments.

FIG. 3 illustrates a cross-sectional view of an electronic device powered by a fuel cell power source lacking a cover, according to some embodiments.

FIG. 4 illustrates a cross-sectional view of an electronic device powered by a fuel cell power source including a refueling port, according to some embodiments.

FIG. 5 illustrates a cross-sectional view of an electronic device powered by a fuel cell power source including external fuel cell components, according to some embodiments.

FIG. 6 illustrates a cross-sectional view of an electronic device powered by a fuel cell power source including a protrusion, according to some embodiments.

FIG. 7 illustrates a cross-sectional view of a fuel cell power source coupled to a stand-alone battery holder and in connection with a device, according to some embodiments.

FIG. 8 illustrates a block flow diagram of a method of making a fuel cell power source for powering an electronic device, according to some embodiments.

FIG. 9 illustrates a block flow diagram of a method of using a fuel cell power source to power an electronic device, according to some embodiments.

### SUMMARY

Embodiments of the invention relate to a fuel cell power source comprising one or more fuel cells, one or more power conditioning components in contact with the one or more fuel cells, fuel storage, an exterior casing in contact with one or more of the fuel cells, power conditioning components or fuel storage, and two or more outputs, wherein at least a portion of the exterior casing is conformed to fit within an existing battery enclosure of an electronic device, such that the outputs are in contact with connections of the existing battery enclosure. Embodiments also relate to a fuel cell power source system comprising an electronic device and a fuel cell power source.

Embodiments of the invention also relate to a method of making a fuel cell power source comprising forming one or more fuel cells, forming a fuel storage, forming an exterior casing, coupling the exterior casing to the one or more fuel cells and forming two or more outputs in the exterior casing, wherein at least a portion of the exterior casing is conformed to fit within an existing battery enclosure of an electronic device, such that the outputs are in contact with connections of the existing battery enclosure. Embodiments also relate to a method of using a fuel cell power source comprising electrically connecting a fuel cell power source to an electronic device.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive or unless otherwise indicated. In addition, it is to be understood that the phraseology or terminology employed herein, and not otherwise defined, is for the purpose of description only and not of limitation. In the event of inconsistent usages between this document and those documents so incorporated by reference, the usage in the incorporated reference should be considered supplementary to that of this document; for irreconcilable inconsistencies, the usage in this document controls.

Embodiments of the present invention relate to a portable fuel cell power source that can be conformed to fit within an existing battery enclosure of a battery-powered device. The fuel cell power source may have equivalent electrical properties as the batteries being replaced (e.g., current, voltage, power, state of charge indication or encryption capabilities). Embodiments of the present invention extend the range of battery-powered devices without the need for modification and allow for power to be replenished without interrupting the operation of the device. Because little or no modifications to the existing device are made, the fuel cell power source is interchangeable with batteries, if such a need arises.

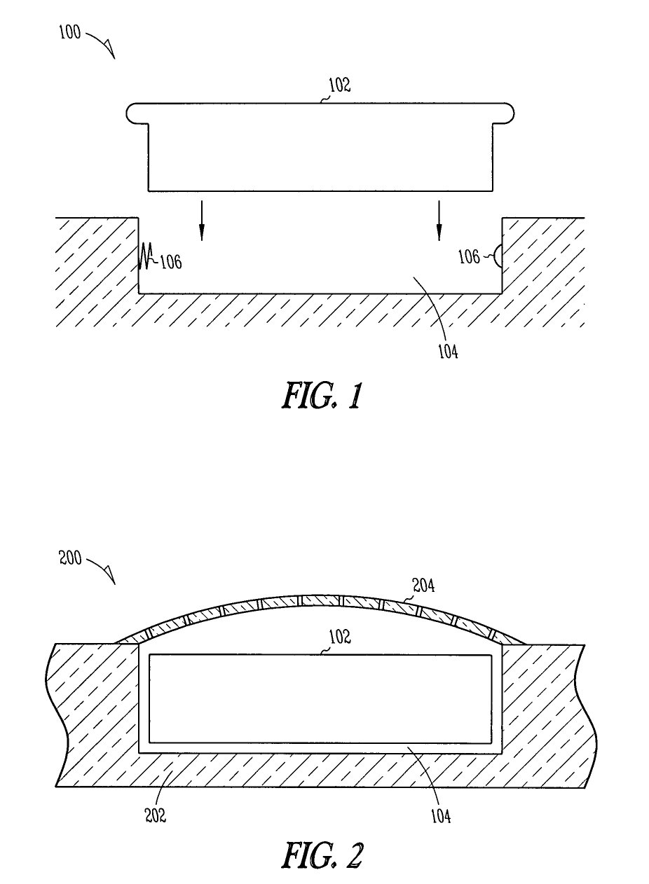

Referring to FIG. 1, a cross-sectional view of an electronic device 100 powered by a fuel cell power source is shown, according to some embodiments. The fuel cell power source 102 may be conformed to fit within the existing battery enclosure 104 of an electronic device. The outputs of the fuel cell power source 102 may be in contact with the connections 106 of the battery enclosure 104. The fuel cell power source 102 may be comprised of one or more fuel cells, fuel storage, an exterior casing to surround the one or more fuel cells, one or more power conditioning components, and two or more outputs. The exterior casing may be in contact with one or more of the fuel cell power source components, but some components may also be exterior to the casing.

The one or more fuel cells may comprise such components as anodes, cathodes, membranes, electrolyte, etc. The fuel storage may comprise a fuel plenum, an internal reservoir, a fuel cartridge or combinations thereof. In addition to the one or more fuel cells, the fuel cell power source 102 may also include a separate, extra or expanded fuel storage area, power conditioning electronics, fluidic controls or an optional refueling port. The arrangement of such components is flexible and may be adapted to best suit the configuration of the existing battery enclosure. The fuel cell power source 102 may also optionally include a means of attachment to a device, such as a latch, strap, snap, clip, buckle, spring, groove, protrusion or combinations thereof, for example. Such a means of attachment would hold fast the power source 102 during any movement of the device to which it is coupled. The one or more power conditioning components may include a DC/DC converter, hybridizing battery, capacitor or any such component that may alter the power produced by the fuel cell before contacting the electronic device.

The outputs of the power source 102 may be utilized for electrical communication or transferring of information, such as status information. In addition to transferring electricity (e.g., current, voltage, power) or electrical communication, the outputs may be utilized for encryption or security purposes or for a state of charge indication. The outputs of the power source 102 may mirror the outputs of the batteries in which it replaces.

The existing battery enclosure 104 may be designed for use with 1, 2, 3, 4 or more primary or secondary batteries. The batteries may be arranged in series, parallel or combinations of series and parallel electrical connections in order to provide a service voltage of 1.5V, 3V, 3.7V, 4.5V, 6V or higher voltage to the device being powered. The batteries may be AA, AAA, C, D, lithium-ion or lithium metal. Examples of lithium-ion batteries include CR-123A and CR-V3 type secondary batteries. Examples of lithium metal batteries include CR2 and PL123A type primary batteries. Battery configurations may include dual AA packs side-by-side or in series, quad AA packs in flat or bundled arrangement, etc. Battery configurations may also include prismatic shapes, irregular shapes or any shape currently utilized in battery-powered electronic devices.

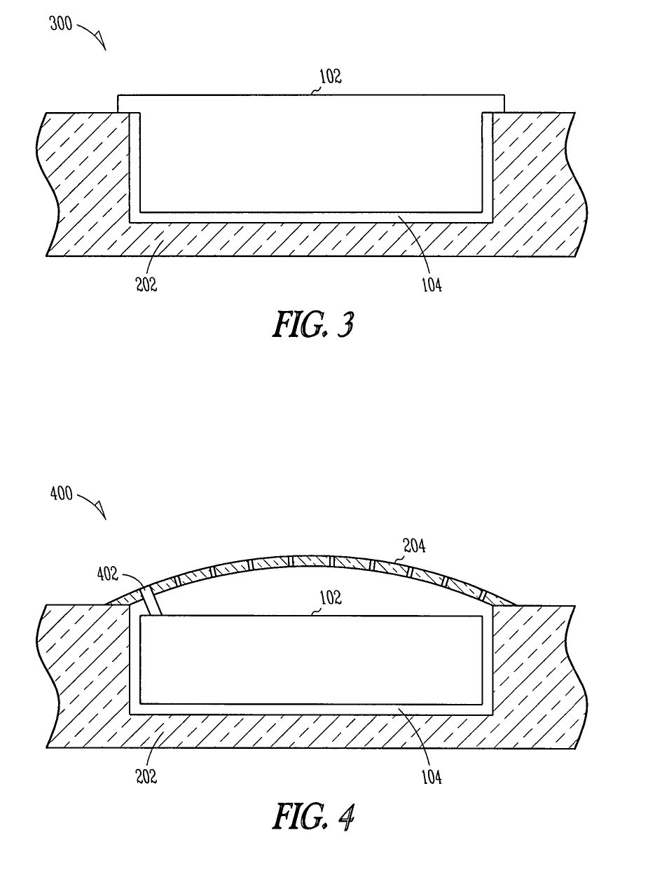

Referring to FIG. 2, a cross-sectional view of an electronic device 200 powered by a fuel cell power source utilizing a modified cover is shown, according to some embodiments. All or a portion of the fuel cell power source 102 may be conformed to fit within the existing battery enclosure 104 of an electronic device 202. An optional modified cover 204 may be secured over the fuel cell power source 102. The modified cover 204 may replace the cover used over the existing battery enclosure. The modified cover 204 may include a means in which air can flow to the one or more fuel cells, such as by holes, vents, slots or screens, for example. The air may move passively or actively. The fuel cell power source 102 may also utilize an active means of contacting air with the one or more fuel cells, such as with an air pump or blower, for example. In FIG. 3, the cross-sectional view of an electronic device 300 shows a portion of the fuel cell power source 102 acting as a replacement cover to the existing battery enclosure 104 of the electronic device 202.

Examples of an electronic device 202 may comprise a cellular phone, satellite phone, personal digital assistant (PDA), laptop computer, ultra mobile personal computer, computer accessory, display, personal audio or video player, medical device, television, transmitter, receiver, lighting device, electronic toy, camera, radio, or scanner.

Referring to FIG. 4, a cross-sectional view of an electronic device powered by a fuel cell power source including a refueling port is shown, according to some embodiments. The refueling port 402 may be used with a modified cover 204 or formed directly in the fuel cell power source 102, when no cover is used. The refueling port 402 may be fluidically connected to the fuel storage, for example. The refueling port 402 may allow for refilling of the fuel cell power source 102 while a device 202 continues to operate, with no interruption or time off-line. The fuel cell power source 102 may be the same size or smaller than the batteries used in the existing battery enclosure 104. The fuel cell power source 102 may be similarly shaped to any batteries manufactured to function within the existing battery enclosure 104. A range extension of the device would be possible as the fuel cell power source 102 would have a higher volumetric energy density than the previously used batteries and would have the ability to be replenished.

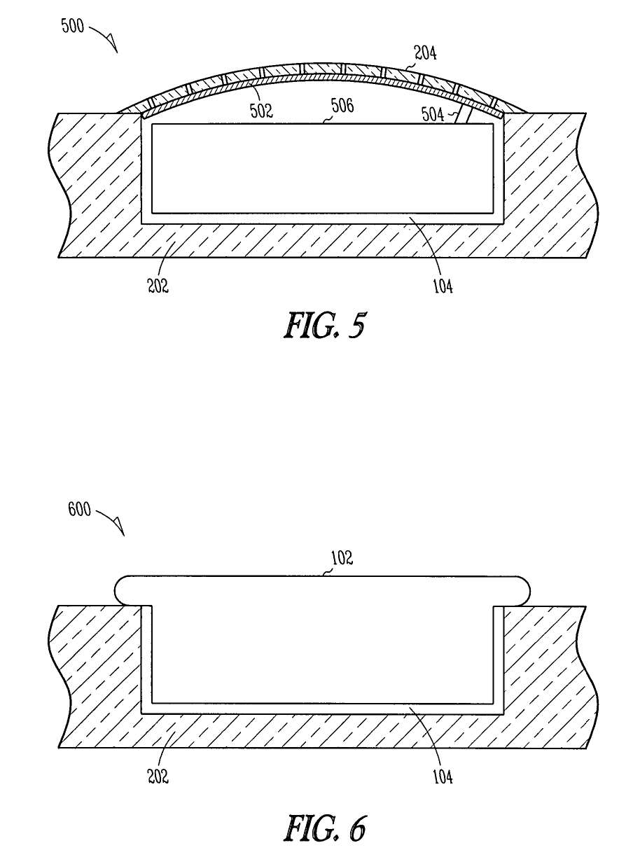

Referring to FIG. 5, a cross-sectional view of an electronic device 500 powered by a fuel cell power source including external fuel cell components, according to some embodiments. The fuel cell power source 506 may utilize one or more fuel cell components 502 that are external to the power source 506. The one or more components 502 may be integrated into, positioned adjacent or near the modified cover 204. An interface 504 between the power source 506 and components 502 may be utilized to communicate electrically, transfer fuel, transfer electrical power, current, voltage or relay status information, for example.

The one or more fuel cell components 502 may include fuel cells, fluid regulators, fuel storage or portions of the fuel storage, fluidic controls, power conditioning components, or some combination thereof. By positioning some fuel cell components 502 external (e.g., near the cover 204) from the power source 506 positioned in the existing battery enclosure 104, the access of the fuel cell to air may be increased while also increasing available volume for fuel.

The fuel cell power source 102 may optionally be sized much larger than the batteries previously used (see FIG. 6). In this case, only a portion of the exterior casing of the fuel cell power source 102 would be conformed to fit within the existing battery enclosure 104 of the electronic device 202. The additional volume may be used for additional fuel storage, further increasing the range of the device. The enlarged volume of fuel cell power source 102 may allow for the addition of optional fluidic or structural features, such as a valve, vent, cap, fitting, regulator, pressure relief device, flow element (i.e., flow restrictor), connector, fastener, mounting flange, boss, etc.

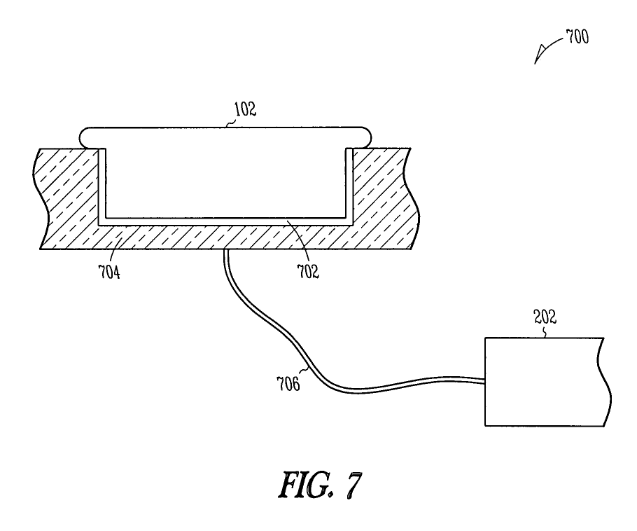

Referring to FIG. 7, a cross-sectional view 700 of a fuel cell power source 102 coupled to a stand-alone battery holder 704 and in connection with a device 202 is shown, according to some embodiments. A fuel cell power source 102 coupled to a stand-alone battery holder 704 by an existing battery enclosure 702, could act as an independent power source to a device 202. An electrical connection 706, such as a USB standard output or charging line specific to a product, allows for the device to be charged from the stand-alone battery holder 704. The holder 704 would contain the necessary power conditioning electronics built into it to provide the proper electrical connection for one or more electronic devices. Thus, the fuel cell power source 102 could work with many types of stand-alone battery holders 704. The use of such a holder 704 allows the fuel cell power source 102 to be used as an external range extender, as well as a primary battery replacement in existing electronic devices.

Referring to FIG. 8, a block flow diagram of a method 800 of making a fuel cell power source for powering an electronic device is shown, according to some embodiments. One or more fuel cells may be formed 802. A fuel storage may be formed 804. An exterior casing may be formed 806. The exterior casing may be coupled 808 to the one or more fuel cells, the fuel storage or a combination of the one or more fuel cells or fuel storage. Two or more outputs may be formed 810 in the exterior casing. One or more power conditioning components may be formed. The power conditioning components may be coupled to the one or more fuel cells. The exterior casing may also be coupled to the one or more power conditioning components.

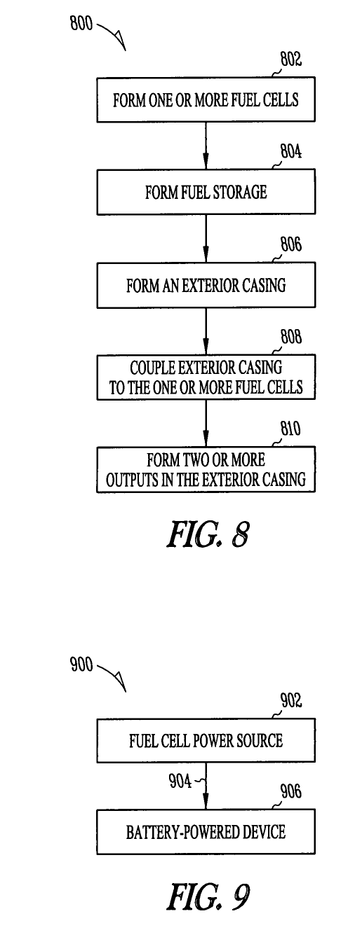

Referring to FIG. 9, a block flow diagram of a method 900 of using a fuel cell power source to power an electronic device is shown, according to some embodiments. A fuel cell power source 902 may be electrically coupled 904 to a battery-powered device 906.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A fuel cell power source comprising:
one or more fuel cells;
one or more power conditioning components, in contact with the one or more fuel cells;
fuel storage; and
an exterior casing, in contact with one or more of the fuel cells, power conditioning components or fuel storage; and
two or more outputs;
wherein at least a portion of the exterior casing is conformed to fit within an existing battery enclosure of an electronic device, such that the outputs are in contact with connections of the existing battery enclosure.

2. The fuel cell power source of claim 1, further comprising a refueling port, in contact with the fuel storage.

3. The fuel cell power source of claim 1, further comprising a modified cover, adapted to enclose the fuel cell power source within the existing battery enclosure.

4. The fuel cell power source of claim 3, wherein one or more of the fuel cells, power conditioning components or fuel storage are external to the casing and near the modified cover.

5. The fuel cell power source of claim 3, wherein one or more of the fuel cells, power conditioning components or fuel storage are external to the casing and integrated into the modified cover.

6. The fuel cell power source of claim 3, wherein the modified cover allows air to pass through the cover and contact the one or more fuel cells.

7. The fuel cell power source of claim 1, wherein the electrical properties are substantially the same as equivalent batteries manufactured to function in the existing battery enclosure.

8. The fuel cell power source of claim 7, wherein electrical properties include current, voltage, power, state of charge indication or encryption capabilities.

9. The fuel cell power source of claim 1, wherein the one or more power conditioning components comprise a DC/DC converter, hybridizing battery, capacitor or combinations thereof.

10. The fuel cell power source of claim 1, wherein the outputs comprises electrical outputs, encryption/security outputs, state of charge indicators or a combination thereof.

11. The fuel cell power source of claim 1, wherein the fuel cell power source protrudes from the existing battery enclosure.

12. The fuel cell power source of claim 11, wherein the portion that protrudes comprises expanded fuel storage.

13. The fuel cell power source of claim 11, wherein the portion that protrudes comprises one or more fuel cells.

14. The fuel cell power source of claim 1, wherein the fuel cell power source actively contacts air with the one or more fuel cells.

15. The fuel cell power source of claim 14, wherein actively comprises using an air pump or blower.

16. The fuel cell power source of claim 1, wherein air passively contacts the one or more fuel cells.

17. The fuel cell power source of claim 1, further comprising a latch, strap, snap, clip, buckle, spring, groove, protrusion or combinations thereof, adapted to hold the fuel cell power source within the existing battery enclosure.

18. The fuel cell power source of claim 1, wherein the fuel cell power source is sized substantially the same as equivalent batteries manufactured to function in the existing battery enclosure.

19. The fuel cell power source of claim 1, wherein the fuel cell power source is sized smaller than the equivalent batteries manufactured to function in the existing battery enclosure.

20. The fuel cell power source of claim 1, wherein the fuel cell power source is shaped substantially the same as the equivalent batteries manufactured to function in the existing battery enclosure.

21. The fuel cell power source of claim 1, wherein the fuel cell power source is conformed to fit within an existing battery enclosure designed for one or more primary or secondary batteries.

22. The fuel cell power source of claim 1, wherein the fuel cell power source is conformed to fit within an existing battery enclosure designed for one or more AA batteries.

23. The fuel cell power source of claim 1, wherein the fuel cell power source is conformed to fit within an existing battery enclosure designed for one or more AAA batteries.

24. The fuel cell power source of claim 1, wherein the fuel cell power source is conformed to fit within an existing battery enclosure designed for one or more C batteries.

25. The fuel cell power source of claim 1, wherein the fuel cell power source is conformed to fit within an existing battery enclosure designed for one or more D batteries.

26. The fuel cell power source of claim 1, wherein the fuel cell power source is conformed to fit within an existing battery enclosure designed for one or more lithium-ion batteries.

27. The fuel cell power source of claim 1, wherein the fuel cell power source is conformed to fit within an existing battery enclosure designed for one or more lithium metal batteries.

28. The fuel cell power source of claim 26, wherein the one or more lithium-ion batteries comprise CR-123A or CR-V3 type secondary batteries.

29. The fuel cell power source of claim 27, wherein the one or more lithium metal batteries comprise CR2 or PL123A type primary batteries.

30. A fuel cell power source system comprising:
an electronic device; and
a fuel cell power source, comprising:
one or more fuel cells;
one or more power conditioning components, in contact with the one or more fuel cells;
fuel storage; and
an exterior casing, in contact with one or more of the fuel cells;
power conditioning components or fuel storage;
two or more outputs;
wherein at least a portion of the exterior casing is conformed to fit within an existing battery enclosure of the electronic device, such that the outputs are in contact with connections of the existing battery enclosure.

31. The fuel cell power source system of claim 30, wherein the electronic device comprises a cellular phone, satellite phone, PDA, laptop computer, ultra mobile personal computer, computer accessory, display, personal audio or video player, medical device, television, transmitter, receiver, lighting device, electronic toy, camera, radio, or scanner.

32. A method of making a fuel cell power source comprising:
forming one or more fuel cells;
forming a fuel storage;
forming an exterior casing;
coupling the exterior casing to the one or more fuel cells; and
forming two or more outputs in the exterior casing;
wherein at least a portion of the exterior casing is conformed to fit within an existing battery enclosure of an electronic device, such that the outputs are in contact with connections of the existing battery enclosure.

33. The method of claim 32, further comprising forming one or more power conditioning components.

34. A method of using a fuel cell power source comprising:
electrically connecting a fuel cell power source to an electronic device;
wherein the fuel cell power source comprises,
one or more fuel cells;
one or more power conditioning components, in contact with the one or more fuel cells;
fuel storage;
an exterior casing, in contact with one or more of the fuel cells;
power conditioning components or fuel storage; and
two or more outputs;
wherein at least a portion of the exterior casing is conformed to fit within an existing battery enclosure of the electronic device, such that the outputs are in contact with connections of the existing battery enclosure.
